(19) United States
(12) Patent Application Publication
(10) Pub. No.: US 2005/0031096 A1
(43) Pub. Date: Feb. 10, 2005

(54) Command synchronization method and system

(76) Inventor: Richard Postrel, Miami Beach, FL (US)

Correspondence Address: ANTHONY R BARKUME, 20 GATEWAY LANE, MANORVILLE, NY, 11949, US

(21) Appl. No.: 10/823,407

(22) Filed: Apr. 12, 2004

Related U.S. Application Data
(60) Provisional application No. 60/462,079, filed on Apr. 11, 2003.

(51) Int. Cl. H04M 1/64

(52) U.S. Cl. 379/88.22; 379/88.12

(57) ABSTRACT

The present invention is a method of operating a notification and response system. First, a unique contact address is assigned to each of a multiplicity of persons in a region. Any of the multiplicity of persons may then become a user of the notification and response system by being registered with the notification and response system. A profile is generated for each user, the profile having parameters for that user that indicate at least one group to which the user belongs. A message is generated for broadcast transmission to a group of users, the message having a set of rules associated with it to indicate which of the users that are intended to receive the message based on user parameters. The message is then broadcast, utilizing the unique contact address of each user in the group, to a group of users based on the parameters of each user that correlate to a rule associated with the message being transmitted.

### CROSS-REFERENCE TO OTHER APPLICATIONS

This patent application claims filing priority of co-pending U.S. provisional patent application Ser. No. 60/462,079, filed on Apr. 11, 2003.

### BACKGROUND OF THE INVENTION

The present invention relates to communications systems, and in particular to a universal communications and command synchronization system that utilizes existing communications infrastructure such as voice, fax, email, cellular networks, instant messaging, television, and the like, for enabling message originators to reach recipients at one or more of several locations, for enabling a user to contact multitudes of recipients in an effective manner, and for providing real time feedback from the recipients useful for modifying subsequent message content and recipients.

Numerous types of systems exist that enable communications between people by various methodologies and technologies; for example, landline telephone (POTS), facsimiles, emails, instant messages, cellular telephone, satellite telephone, pagers, etc. Often, a person is accessible by only a subset (or even only one) of these methodologies; for example, when the person is traveling he may only be accessible by cell phone, or he may only be accessible by email via a two-way pager, etc. Even if a person is available by more than one technology, he may have a preferred mode of communications; for example, a landline telephone is generally preferred over a cell phone for quality and cost reasons, or an email may be preferred over a telephone call if the person does not wish to be disturbed, etc. Moreover, a person usually has more than one of each of these modes available; i.e. a person may have an office line and a home line, two or three emails, two cell phones, etc.

A natural result of the various communications modes is that a sender (i.e., someone trying to establish communications with another party) trying to reach a recipient either does not know the preferred mode of communications for that recipient, or does not know which mode is available at a given time, or does not even know how to reach the recipient for a give mode (i.e. he does not have the recipient's cell phone number, only his office number). Thus, establishing efficient and timely communications with a recipient is quite problematic.

In addition, persons often desire certain controls over the manner in which they receive communications from the various senders, depending on the identity of the sender, the time of day, the location of the recipient, etc. For example, a person may be attending an important meeting, in which he wants to screen out phone calls from everyone except a certain business associate.

These aforementioned issues relate to communications with a person on the “inbound” side; i.e. establishing communications with a person from the outside world in to the person. Issues also exist on what is termed the “outbound” side, which relate to the need for a person to communicate with one or more other people in parallel, simultaneously (or nearly simultaneously), such as when a fire station dispatcher needs to call in all emergency personnel to an emergency site, or even if a civil warning system needs to alert all persons in a geographic region in a disaster condition (e.g. an approaching tornado). Prior art systems used for such mass communications are limited and arcane, such as a siren that is sounded at a firehouse, or a group email sent to multiple individuals simultaneously. These prior art systems do not provide feedback to confirm receipt of the message, nor do they provide a means to continuously attempt successive communications of confirmation is not received, etc.

Furthermore, these prior art systems do not provide a means for obtaining information from message recipients, including data actively input by the message recipients and returned to the message originator, data passively gathered by the system and returned to the message originator, as well as message receipt confirmation information. These prior art systems do not provide a mechanism for utilizing such data obtained from message recipients and modifying subsequent data messages and recipients according to the data obtained.

Thus, both the inbound and the outbound communications problems of today's society are not met by the existing technologies and methodologies, and are even exacerbated by them. The present invention solves these problems as described herein.

### SUMMARY OF THE INVENTION

The present invention is a method of operating a command synchronization and notification and response system. First, a unique contact address is assigned to each of a multiplicity of persons in a region. Any of the multiplicity of persons may then become a user of the notification and response system by being registered with the notification and response system. A profile is generated for each user, the profile having parameters for that user that indicate at least one group to which the user belongs. A message is generated for broadcast transmission to a group of users, the message having a set of rules associated with it to indicate which of the users that are intended to receive the message based on user parameters. The message is then broadcast, utilizing the unique contact address of each user in the group, to a group of users based on the parameters of each user that correlate to a rule associated with the message being transmitted.

Information may be fed back to the system and returned to the message originator, including data actively input by the message recipients, data passively gathered by the system and returned to the message originator, as well as message receipt confirmation information. The present invention provides a mechanism for utilizing such data obtained from message recipients and modifying subsequent data messages and recipients according to the data obtained.

### BRIEF DESCRIPTION OF THE DRAWING

FIG. 1 is a block diagram of the present invention; and

FIG. 2 illustrates incoming call routing in accordance with the present invention.

### DETAILED DESCRIPTION OF THE PREFERRED EMBODIMENT

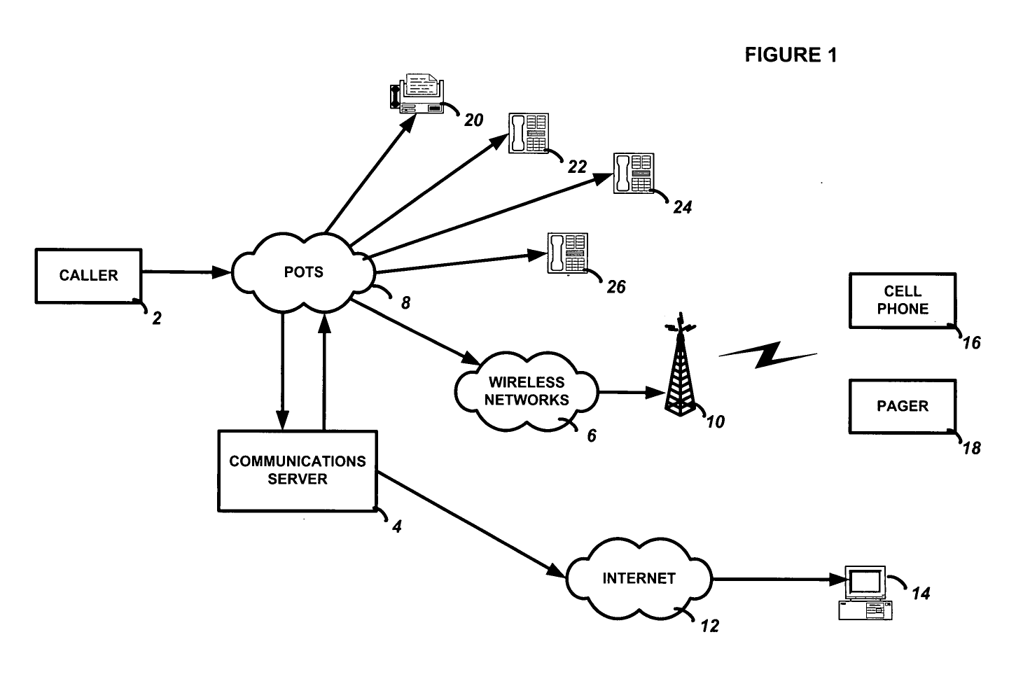

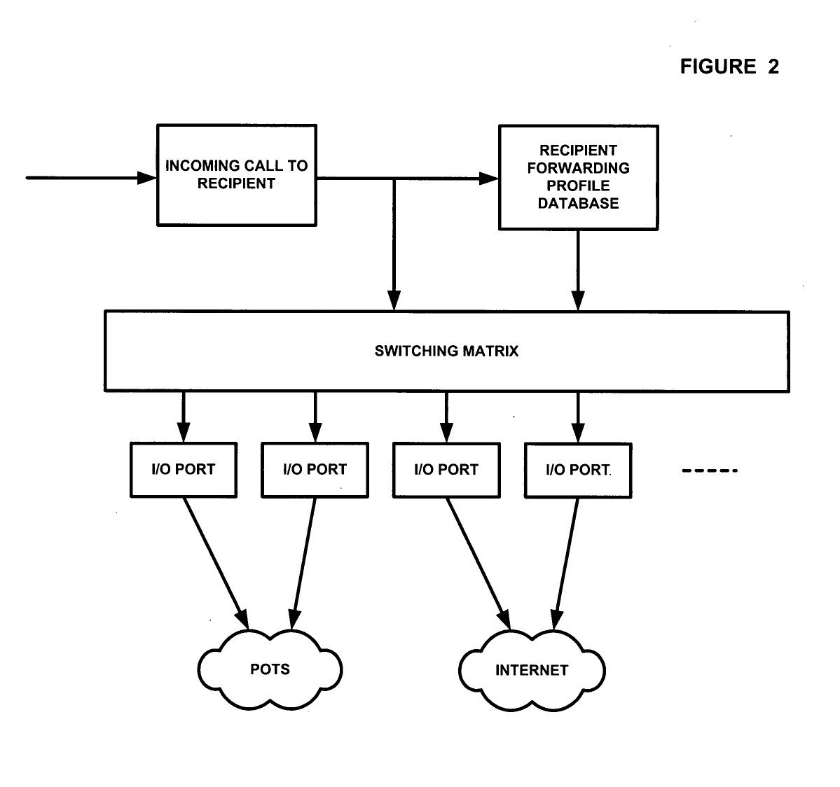

Referring generally to FIGS. 1 and 2, the present invention is a universal communications system that utilizes the existing communications infrastructures to provide unified inbound and outbound messaging services that are tailored to the need of an individual or an entire organization. A central communications server is provided that is accessible by each user via a web-based interface and/or a telephone interface, as desired. Users or organizations may subscribe to the universal communications service in order to obtain the benefits on the inbound and/or outbound platforms, although non-subscribers may of course by contacted by (or make contact with) the subscribers as described herein.

### Inbound Communication Services

A user that has subscribed to the service is provided with a toll-free telephone number that will be used by anyone desiring to communicate with the user. In one embodiment, the toll-free number is configured as an extension of his or her existing phone number, with a three-digit toll-free area code added to the beginning. Thus, if a user already has the phone number 212-555-1234, and the service has adopted the toll-free area code 855, then the person's universal number for purposes of this invention would be 855-212-555-1234. The telephone network would be adapted to allow for the detection of the toll-free area code and switching of the call to the service, where the remaining ten digits (which have been pre-assigned to the user since that is his unique phone number already) are decoded to link to the user's account herein. In an alternative embodiment, a user may be given a new toll-free number, such as 888-555-6789, which is mapped to the user by the service. (Described below is also an embodiment utilizing the social security number of a person, which provides a completely unique phone number for each person in the country).

After being registered with the service (which can charge users monthly, yearly etc. or on a per-call/response/transactional basis) and receiving his toll free number, the user will set up his account through a web interface or a telephone DTMF menu system. When using a web-base interface, the user logs onto the server's web site (e.g. http://www.universalcommunications.com), and then login with his user name or number and a password or PIN. The user will then be served a web page that is accessible to only him or a system administrator as well known in the art.

Call Forwarding

The user's home page will contain various links, which allow him to control this inbound side of the system. The user accesses a setup portion, by first clicking on the call forwarding link, and then adding his “locations”. These locations each describe information about a user's location, such as the phone number of that location, a description, the phone type (cell/land), a dial wait time, and a “connection protection” indication. If connection protection is enabled on a given phone number location, then if during a conversation with a caller the signal is dropped, the caller is not hung-up on, but instead is told to hold on while the user is re-connected.

A chart of forwarding hours is also provided, in which the user specifies the days and times that he wants calls to be forwarded to that location. Thus, for example, a user may enter location data for his work number, his cell number, and his home number as follows:

| | | | |
|---|---|---|---|
| Work Location: | 212-555-7465 | M, T, W, Th, F | 9 AM-6 PM |
| Cell Phone Location: | 631-555-8747 | M, T, W, Th, F | 8 AM-9 AM |
| | | M, T, W, Th, F | 6 PM-7 PM |
| Rome Phone Location: | 516-555-1876 | M, T, W, Th, F | 12 AM-8 AM |
| | | M, T, W, Th, F | 7 PM-12 AM |
| | | Sat, Sun | All day |

When a caller dials the user's universal number, the call is forwarded by the service to the appropriate number above depending on the day of the week and the time of the day. This information may be modified by the user at anytime by accessing this web page, or by dialing into the system and stepping through a DTMF option menu as known in the art. By making this information accessible via any web connection or telephone, the user is provided with complete flexibility in controlling his call forwarding information.
Message Forwarding

In the event that a call is placed to a user through the system, but the user cannot answer (or chooses not to), then the caller may leave a voice mail message in the user's voice mail box as known in the art. The present invention also allows the user to specify an email address on the message forwarding page, to which a copy of the voice mail message will be sent. The voice mail may be sent in any of available audio formats, such as a .WAV file or an .MP3 file, whereby the user would play back the message with a media player program on his computer and hear the voice message left form him. In the alternative, the voice message may be converted to a text message by a speech-to-text conversion program, and the message forwarded in text format. This would be especially useful if the user has messages forwarded to a handheld pager device such as a RIM BLACKBERRY device, which may not have audio capabilities and can only display text messages. The user can also specify that incoming faxes are forwarded to a pre-designated fax machine, or to an email account (such as in PDF or TIFF format).

There are various call options that may be designated by the user, such as whether the system should take voicemails, whether the system should inquire who is calling, the type of music for music-on-hold, the name enunciated when the caller is waiting for the system to dial the user's number, and whether the system number should be displayed on caller ID at the forwarded number.

There are also various notification options available with the system. For example, the system may call the user for a pre-designated number of times when a new message is received, or it may send an email with a notification, etc. The system may also be configured to page the user at a preset pager number entered in this web page.

The user also has an address book that is configured by the address book page, which will list all of the user's contacts along with their phone numbers, email addresses, etc. The user may place a call to any recipient by pressing a “call” button next to their name, and a call is placed from the user's computer to the number of the recipient. The call may be made by modem, or it may be a voice over IP call, as may be desired.

The inbox is accessed from the navigational link at the side of any web page, and will show the user all of his voice mail messages that have been received. These messages maybe played back on the user's computer by simply pressing the appropriate button or icon, which will cause the voice mail message to be played for the user. The user may manage the messages by designated folder, or delete the message as desired. The user may also save the message on his local PC for archival purposes if desired.

Automatic Sensing of User Location

The system may be adapted to employ sensors and detectors to determine, in an automatic manner, if a certain user has arrived at a destination location, and then automatically generate a response message to confirm his or her arrival to the system. For example, a user may be provided with an ID card with an RFID chip embedded in the card (such as a smart card), which will uniquely identify that user. An RF ID reader may be located at a checkpoint, such as along an evacuation route, and when that user arrives at that checkpoint, the sensor will read the RFIS chip in the smart card and determine that the user has arrived automatically. A confirmation massage may then be automatically sent to the system to inform it that the user is in that location. This may be used in strategic locations such as governmental buildings, hospitals, evacuation centers, etc. This provides a resource tracking system (where the users are the resources) to generate automatic and real-time updateable knowledge of the locations of these assets without requiring the assets (the users) to have to generate such messages in a manual fashion.

In an alternative embodiment, security measures may be employed wherein a user may have to enter a PIN into a keyboard, or have his fingerprint or retina scanned, etc., to confirm his identity. Thus, a user would approach a secure area, enter his PIN, and a message would be generated indicating his presence at that location and then returned to the system accordingly.

### Outbound Communications Services

The system of the present invention also utilizes an outbound services platform to provide various services such as workgroup messaging, group alerts, and reports relevant to these services as described herein.

One important feature of the present invention is the ability of a user to issue alert messages to one or more recipients and track responses to those alerts to ensure everyone has received the alert. This may be of vital importance, for example, in a case wherein a user desires to issue an alert message to everyone in a geographic area (so-called “reverse 911”) in the case of a disaster such as a tornado. Rather than relying on a siren being sounded, and thus not ensuring that everyone actually has been informed of the emergency, the present invention provides tracking and reporting of the response by each recipient.

Alerts may utilize the concept of a virtual workgroup, for which various persons may be assigned. Persons may belong to different workgroups so that they may receive alerts from different senders or from the same sender based on different events. For example, a volunteer firefighter may belong to a FIRE workgroup and an EVACUATION workgroup, so that he is notified in both cases, while others may only belong to the EVACUATION workgroup. Workgroups are assigned on a system basis, so that each user has access to the same workgroup alerts, or only certain users may have privileges to assign and/or implement workgroups, etc.

In a simple case, user A has defined a workgroup of users B, C, and D. When user A desires to send an alert to that workgroup, he executes an Alert Wizard by selecting the designated link from his home page. First, user A indicates the target audience for the alert as being Public or Private. A private alert may utilize contact information for anyone who is also a subscriber to the system, while a public alert can contact anyone whose contact information has been entered into the system, whether they are a subscriber or not. When a private alert is executed, the system will determine the recipients to be called by analyzing their universal phone number designated by the call alert profile and then connecting the call to the inbound platform (e.g. forward the call to the recipient based on their forwarding profile) without the need to actually dial the number outside of the system (which would just get directed back into the system by the telephone network). The system then locates the user at the location previously designated by the user in his profile. Thus, the user generating the alert does not have to know which number to call at any given time, since the inbound platform of this system will take care of finding the subscribing user. This is especially useful with security and reporting features described below.

A public alert may call users who are not subscribers, and will dial out the number designated for that recipient by the alert initiator. The present invention allows a user to enter contact information en masse by generating a table, such as with Microsoft Excel, which lists each user's name and phone number in a flat file format. The file may be comma delimited, for example, and the system will upload the file from the user's computer over the Internet. The file data will be separated out into columns and the user can indicate to the system which column is the phone number to call during the alert. Since these public users are not subscribers to the system, the system cannot implement the inbound location services described above, but can only dial the one number indicated for each user entry in the flat file.

An alert profile may be called, or a new profile may be entered during this process. If an existing profile is called, the data required by the wizard is populated per the profile, but can be changed on the fly by the user. When a new profile is created, a profile name and text description is entered. Next, the contact media is selected, such that one or more of phone, fax, email, and pager media types are entered. The audio message (if needed for the phone contacts) is either selected from an existing file such as a .WAV file, or it is recorded on the telephone at the time of the alert, or it is generated from a text-to-speech conversion program. The user may enter the text message for conversion, or if audio format is chosen, then the user is instructed to dial into the system and navigate through the DTMF menu and eventually speak the alert message for recording by the system.

When the fax alert option is selected, the user is given a menu of available faxes that can be sent in the alert. If none are available, a mechanism is provided to allow the user to create a fax and send it to his inbox, so it is available for later use.

When the email alert is selected, the user enters the name of the email message and the text of the message. When the pager alert is selected, the user enters the numeric message to be sent out via pager.

The Alert Wizard requests the user to select the message to be sent on the alert, which as previously described is a .WAV file generated by a text to speech utility or otherwise. After the user confirms the content of the message, he is asked if he wants to upload any new flat files (including phone numbers, etc.) for use in the alert. If the user wishes to upload new files, the wizard leads him through the file upload process, or in the alternative, an existing file (i.e. previously uploaded to the server) is selected for use in the alert. After the phone list is selected, the user may review it to ensure it is the one he wants. The user may then select the date and time of the alert (which could be immediate), and other options for the alert such as confirmation of alert received, etc.

The user can then submit the alert profile to the system. When the date and time programmed by the user has been reached, the alert will begin. The system will begin to place calls to each of the recipients on the alert phone list (which may be on a priority basis pre-selected by the caller, or it may be in a random fashion, or in some pre-determined geographical order, etc.). An alert call is generated by the system, and will be placed to user A on the list. When user A answers the call, he will hear a prompt and then the message will be played. He will then be given the choice of confirming receipt by pressing a key on the keypad, or leaving a voice mail message for the alert initiator, or simply hanging up without confirming receipt. The system is capable of executing thousands of simultaneous calls, and is scalable to meet the demands of any environment as required. As a call is completed by a given port, it will queue to the next call, and all ports in the system will eventually place all of the required calls in the alert.

While the system is placing the alert calls, the user that initiated the alert is provided with a status web page updated in real time, for example every 5 seconds, by the system. A table is provided that lists each number called, and the status of that call, which may be queued (call waiting to be placed), calling (call being dialed), alerting (message being played), alerted (message finished playing), re-alerted, confirmed (recipient entered confirm key), replied VM (recipient left a voice mail response), or unavailable (no answer, hangup, or PIN not timely entered). A statistical window is also provided, showing these status indications as relative percentages in a table as well as a graphical chart. These statistics are updated in real time and the alerting user can determine the effectiveness of the alert accordingly. The user can also view a graph of readiness results, which shows a percentage of recipients that have confirmed receipt of the message as a function of the time taken to respond.

Geographic Loading of Phone Numbers in Real Time

In one embodiment of the invention, the user can generate an alert to a specified geographic region, en masse, without needing to input the phone numbers of each person in the region. For example, a user may need to send an alert to all residents in the entire state, or in specified counties, etc., due perhaps to an approaching hurricane. An alert wizard is provided that displays a map of a geographic region of interest, and allows the user to select certain regions, zoom in or out, and even select neighborhoods or blocks, as may be desired. The system will take the selected regions and perform a lookup in a white pages database, which is a repository of phone numbers for a given region. The database is updated periodically, for example once per day, and therefore reflects accurate and timely information regarding the phone numbers of all persons in a designated area. Thus, the alert wizard will obtain the most current phone numbers at the time the alert is generated, and all such persons may be timely provided with the alert. This is advantageous over a static system that may have a database loaded at the client level (i.e. the PC where the alert is being generated) since it is always kept up to date.

Alerts may be pre-configured and stored in profiles as described above, and then called by the user at any time via the web interface or by a phone interface. Thus, an emergency management director for a given region may preconfigure an alert to be issued to all residents in the area, per the above geographic wizard, and simply call in to the system, log in, and enter a preselected DTMF menu that allows him to trigger the alert from anywhere he can call in.

The present invention advantageously allows for multi-channel conferencing between and amongst various participants based on their user profiles, requirements of the alert message being issued, etc.

Security Features

The present invention implements several robust security features. For example, as mentioned above, a private alert will implement a list of recipients that are subscribers to the system. Since the system analyzes the recipients universal phone numbers designated by the alert profile, there is no need to leave the system (i.e. dial out) to implement their call forwarding scheme as designated in their profiles. Thus, the present invention also utilizes, in an alternative embodiment, an alias for each subscriber that is not an actual telephone number. These subscribers are provided with an alias, rather than a telephone number, that is linked to their call forwarding profile. Thus, calls cannot be made by anyone outside the system to these recipients via the system since there is no way for an outside telephone number to connect to them. This provides a firewall-like security measure that is advantageous because, for example, a telemarketing system would not be able to dial to the recipient since there is no universal number associated with the recipient (they could, of course, reach the recipient via the conventional means of his phone number, cell number, email, etc. as in the prior art). Thus, for example, user A could be given the universal number 888-555-8645, which allows anyone to call him at that number and have it forwarded to his designated touch point as described above, or he could be given an alias such as “976b87g5j9”, which is used by alert initiators within the system to reach him but cannot be used outside the system.

Another important security feature of the system provides for anonymous calls being made to recipients, where the caller does not want the recipient to know his identity but still may want the recipient to be able to call him back later on. For example, a caller may want to dial a crisis center such as an AIDS hotline, and have the attendant call him back at a later time, but does not want the attendant to be able to identify him. By calling the hotline through the system and using the caller's universal phone number, the hotline attendant can dial back the universal phone number, even with an alias name, and the system will forward the call to the user without the attendant being able to determine the actual phone number (or identity) of the original caller. Thus, privacy is ensured for those who need to have persons call him without them having their actual contact information, other than the universal phone number.

Various levels of security may be implemented with this invention. Message content may be limited or adapted in accordance with the protocols of the communications channel being used. For example, the system may only allow transmission of low level security messages over a relatively unsecure channel such as a wireless link, and it may allow higher level security messages over a more secure channel such as a landline. In addition, messages may be required to be encrypted based on the level of security required or desired.

The present invention may be utilized, in one embodiment, on a national scale wherein all citizens of the country (e.g. all U.S. citizens) are pre-assigned a unique contact address which is utilized by the notification and response system to communicate with that user by one or more various methods. Thus, a contact address may be a telephone number (cell, home, work, etc.), or it may be an email or instant message address. In one embodiment, the contact address is a telephone number, and it is correlated to the user's social security number. Since virtually every US citizen has a social security number already, it would be advantageous to use that SSN or to correlate that SSN to another unique number (e.g. by a hashing algorithm or the like). Since everyone has a unique social security number, adding a toll or toll-free area-code prefix (e.g. 855) to this provides everyone with a unique universal phone number, available instantaneously without even having to register with the system. In the alternative to using the actual social security number, the system may use a secret mask or hashing function to generate a second, unique number that is a function of the social security number. Since the universal phone number is made publicly available, it is desired to mask the actual social security number but still use it as a basis for generating a new unique number for each citizen. Since the masking algorithm is kept secret, it would be difficult for anyone to reverse-engineer another person's universal phone number to determine their social security number.

Once every citizen in the country has a universal phone number preassigned to him, the service would enable a user to become part of the service (i.e. to become a registered user) by paying a fee, which may be a one time fee, a periodic fee, a per-use fee, etc. For example, the service may allow anyone to access a web site, make a one-time ten dollar payment, and have his subscription enabled with his pre-existing unique phone number. The user could then use the services provided by the system; i.e. have his calls forwarded to him per the call forwarding profile, or call others through the system, etc.

In the alternative, certain parts of the service may be enabled at the outset for everyone, such as the inbound (call forwarding) portion. This enables everyone to use the call forwarding services without paying a fee, and provides a great incentive for users to register. Once the user has registered, he provides his forwarding information and the system can assemble a repository for this information for future use.

Once widespread registration of the system is obtained, many applications are possible. A user, as part of or separate from the registration process, generates a profile that has various parameters in it. The profile for a given user may have geographic information (e.g. where they live or work), biometric information (e.g. fingerprint, DNA, retinal scan data), security access data (e.g. level of Defense Department clearance), occupational parameters (e.g. their job or pertinent skills), demographic parameters, and/or psychographic parameters.

Values may be assigned to various parameters in a user's profile, and an algorithm may be used to calculate a value of a person as a resource for a given situation. For example, a doctor may be assigned a certain value that would be high in a medical emergency but low in other types of emergencies. A high ranking military officer would be assigned a high value in a terrorist emergency, but not in a fire, etc. These values are generated and utilized by the system to determine appropriate personnel to contact in various situations based on the surrounding circumstances.

As a result of the user profile information, groups may be formed by filtering any parameters against a set of rules. For example, a group of users may be defined simply by their zip code where they live, or a group may be defined for all persons in an area with a certain level of DoD security access, or all persons who are nuclear engineers or technicians, etc.

The user profile also contains information regarding how a user may be contacted at any given day or time, such as when he is at work (work telephone or email), or when he is traveling (cell phone), or when he is at home (home telephone or email or instant message address). This information is used by the notification and response system as described above to send a message to user when that user is part of a broadcast group audience.

In one embodiment, different tiers of service are applied; for example, a private business tier (including entities such as corporations), a governmental tier (including agencies such as the Department of Defense, state and local agencies, etc.), and an individual tier (including individual users). Virtual workgroups are generated from the entire population of registered users, with the various tiers obtaining access to certain registered users based on various parameters. For example, governmental agencies in a given locale may be provided with access to registered users in that locale, or agencies such as the Department of Defense would be provided with access to all enlisted personnel and reservists, etc. Private corporations could have a class of service that might provide them with access to certain registered users based on parameters as indicated in the users' profiles, such as demographic, sociographic, psychographic, and/or other types of indicators. Users could indicate their willingness to receive communications of various types, and those users could be matched to varying entities accordingly. Matching and filtering of appropriate registered users based on a set of rules and their registered profiles would thus promote utility in the system. Since an entity can reach multitudes of users in an alert fashion as described above, and since each user would have their forwarding profile accessible to the system, an entity such as the Department of Defense can make contact with every relevant individual with one or several instructions to the system, and have instantaneous feedback data regarding response of the users to the message being sent. This scenario is also advantageous to marketers in the private sector, wherein a company could nearly instantaneously reach large numbers of customers or potential customers in real time, perhaps with an offer for a discount for a certain product at a certain location. Since these merchandising alerts could be tailored to geographic locations, one message could offer a 10% discount to all Floridians while offering a 20% discount to all New Yorkers, etc.

In the event that a message is broadcast to a group of users that are selected based on rules and requirements of the message as they compare to the users' profile parameters, the message will be sent to the contact address of each selected user. The system may use the user profile to determine if an alternative or better way of contacting the user should be followed (such as, for example, if a user indicates that he should always have his cell phone attempted first, regardless of the time of day).

In one embodiment, certain recipients may be targeted for messages based on their capabilities and qualifications as set forth in their user profiles. For example, a message may need to be distributed to users that have a medical background (e.g. doctors, nurses, paramedics, etc.) that would request them to go to an emergency site, such as a building explosion. Similarly, users with profiles indicating that they have firefighting training would be selected as recipients of messages that require firefighting. Further filtering may be done, such as be location, age, etc.

The user may be required to send a confirmation message, such as by pressing a key sequence on the phone keypad, or by sending a reply email, etc. In this scenario, the system will have knowledge of which users have actually received the message, how long it took to reach them, in what manner it reached them, etc. The information collected by the system regarding the confirmation message sent by the user may then be used in several ways. In one embodiment, certain parameters may be modified in the user's profile. For example, if a user was unreachable by the primary mode of contact as indicated in his profile, that primary mode may be modified to be the mode that was in fact successful in reaching the user. In another case, the message (or subsequent permutations of the message) may be modified based on information received in the confirmation message. For example, if a message is broadcast to evacuate a region via a certain roadway, and a user confirms receipt of the message and indicates that the roadway is clogged, then the system may issue subsequent messages to the same group to provide an alternative route of evacuation.

Security measures may be put in place wherein the identity of a user is verified via information received in the confirmation message. For example, it would be desired to determine if someone is trying to spoof the system. If a message with secret information is sent to a user who has a high level of security clearance, then that user may be required to enter a password or PIN in his confirmation message so the system knows that he is authentic and that the message was not intercepted by an unauthorized user. The user may also be required to provide biometric data, such as by using a retinal scan device at the point of receiving the message.

Command Synchronization

Information may be fed back into the system to enable modification of subsequent message content, message recipients, and modes of message delivery, based on the feedback data. This provides for synchronization of feedback data with the message content and recipients. The system will provide for intelligent decision making based on data feedback or otherwise gathered by the system, both actively and passively. Feedback data may be used to refine the targeting of subsequent notification massages, and even provide an artificial intelligence for further message content and recipient refinements.

For example, a situation may develop which would require evacuation of a defined geographic region such as a flooding of a coastal area. A group of recipients would be defined, which would include all residents of that coastal area, as well as people who are known to work in that area even if they do not live there. By implementing appropriate filters with users' profiles (e.g. where they work or live), the initial target group would be defined. An evacuation notification message would be generated and broadcast to the group of recipients as defined above, instructing the recipients to evacuate the region. The message may have an instruction to utilize a certain road for evacuation, such as a major highway. If a recipient of the message encounters heavy traffic or other obstacles to evacuation on that route, he would feed this information back to the message system and the system would intelligently revise the message to instruct recipients to use a different, alternative evacuation route. The new message would be sent to the group, or to a subset of the group (perhaps only those closest to the alternative route), which would instruct them accordingly. Subsequent data may be fed back into the system for further modifications of the message content and targeted recipients, so that the intelligence of the system may be used to adapt the messages in an advantageous manner. This is referred to as command synchronization since it enable synchronization of messages and targeted recipients with information fed back from other recipients in order to maximize the effectiveness of the system.

Responses may be tracked and displayed graphically in any display format that enables the viewer to quickly and intuitively assess the performance of the message transmission and confirmation. Adjustments may then be made to optimize the response performance, as will be shown on the graphical display.

In another embodiment, a smart card is used instead of, or as an adjunct to, the database stored on the server. An alert profile maybe stored on the smart card, rather than on the server, for security purposes, for sake of convenience and mobility, etc. When a user desires to issue an alert as defined by the parameters on the smart card, the user accesses a smart card reader networked to the communications server (e.g. over the Internet), swipes the card, and appropriate commands and data are sent to the server to enable the server to initiate the alert accordingly. The smart card may also be used to store response data, such as the identification of responding recipients, time to respond, response messages, etc. This data may be transferred at a later date to a computer for use by the alert initiator in determining the effectiveness of the alert, etc.

The present invention also utilizes intelligence at several levels in carrying out its functions. The system keeps track of effective responsiveness of various alerts, in particular it tracks how quickly certain persons respond to an alert, and whether certain contact media is more successful than others. For example, a person may be reachable quicker on his pager than on his cell phone, or vice versa, etc. This information can be analyzed by the system and used for predictive analysis on future alerts, making suggestions to both alert initiators as well as recipients as to which contact media may be preferable for a given recipient, perhaps as a function of time of day, day of week, etc. The response effective analysis may also be acted on automatically by the system, for example, if the alert initiator indicates that the system should choose the most effective medium for making contact at a given time. Although the system may be instructed to use all available contact media simultaneously in an emergency (for example, if there is a bomb scare in a building, then issue alerts to everyone in the building and nearby with all possible contact media simultaneously so as not to waste any time in reaching the recipients), the simultaneous alert issuance may not be practical for large scale alerts, such as if an entire state or region needed to evacuate in the event of an impending disaster. That is, if for example millions of recipients need to be reached immediately, and the system tried to use all possible contact media to reach them, there might be undue delay due to the sheer volume of calls to be placed. In this case, having a predefined intelligence determine the best response methodology for each user is advantageous. That is, recipients would be contacted based on the intelligent analysis of the system as to best way to reach them, despite their preconfigured profile, and that mode of communications would be utilized by the system for that recipient.

In another embodiment, the communications system is interactive in several ways. For example, a caller may dial a recipient's universal number, and be connected to an interactive voice response (IVR) system that will ask for certain information, such as the name of the caller and then the purpose of the call. This information may be obtained by spoken responses or keypresses in response to hearing a DTMF menu. This information may be forwarded to the recipient so that he may decide to take the call or not. The recipient could also cause the system to ask further questions, in real time, by pressing certain keys on his phone or keyboard. For example, after the system determines that the caller is Joe Smith and the purpose of the call is business, the recipient may press a menu option to cause the system to ask the caller another question, such as the name of his company, etc. The system acts as a virtual secretary, screening out callers as desired by the recipient, without the caller knowing that the recipient is actually asking the questions. The recipient could also type the questions on a computer keyboard, which could be relayed back the caller via text-to-voice conversion. This provides for fine tuning of the questions in the event they are not already stored in the system.

In another embodiment, the call may actually be forwarded differently depending on responses to an initial question, such as “personal or business?”. In this case, a personal call may be forwarded to a home line, while a business call may be forwarded to a business line or a cell phone, etc.

1. A method of operating a notification and response system comprising the steps of:
a. assigning a unique contact address to each of a multiplicity of persons in a region;
b. enabling any of the multiplicity of persons to become a user of the notification and response system by being registered with the notification and response system;
c. generating a profile for each user, the profile comprising parameters for that user that indicate at least one group to which the user belongs;
d. generating a message for broadcast transmission to a group of users, said message having associated therewith a set of rules indicating which of the users that are intended to receive said message based on user parameters;
e. broadcasting, utilizing the unique contact address of each user in the group, the message to a group of users based on the parameters of each user that correlate to a rule associated with the message being transmitted.

2. The method of claim 1 wherein the unique contact address is used to access a user profile, the user profile indicating a plurality of alternative contact modes for that user, and wherein at least one of the alternative contact modes is utilized to transmit the message to that user.

3. The method of claim 2 wherein the user profile indicates when different alternative contact modes may be used at different times or days.

4. The method of claim 1 wherein the unique contact address is correlated to the user's social security number.

5. The method of claim 1 wherein the unique contact address of each user is a telephone number.

6. The method of claim 1 wherein the unique contact address of each user is an email address.

7. The method of claim 1 wherein the unique contact address of each user is an instant message address.

8. The method of claim 1 wherein groups of users are defined by geographic parameters in the users' profiles.

9. The method of claim 1 wherein groups of users are defined by biometric parameters in the users' profiles.

10. The method of claim 1 wherein groups of users are defined by security access parameters in the users' profiles.

11. The method of claim 1 wherein groups of users are defined by occupational parameters in the users' profiles.

12. The method of claim 1 wherein groups of users are defined by demographic parameters in the users' profiles.

13. The method of claim 1 wherein groups of users are defined by psychographic parameters in the users' profiles.

14. The method of claim 1 wherein groups of users are defined by sociographic parameters in the users' profiles.

15. The method of claim 1 wherein hierarchies of groups are defined and wherein users may belong to more than one group.

16. The method of claim 1 further comprising the step of modifying parameters in a user profile by an authorized user of the system.

17. The method of claim 1 wherein the step of enabling any of the multiplicity of persons to become a user of the notification and response system by registering with the notification and response system comprises:
i. providing registration procedure information to each of the persons;
ii. accepting payment of a registration fee from any of the persons desiring to register with the notification and response system; and
iii. indicating in a database associated with the emergency system that a person who has paid the registration fee is a registered user of the notification and response system.

18. The method of claim 1 further comprising the step of:
f. a user that receives the message transmits a confirmation message to the notification and response system.

19. The method of claim 18 further comprising the step of:
g. modifying the user's profile based on parameters of the confirmation message received from the user.

20. The method of claim 18 further comprising the step of:
g. modifying the content of subsequent messages transmitted to other users based on parameters of the confirmation message received from the user.

21. The method of claim 18 further comprising the step of
g. after failing to receive a confirmation message from a user after a predetermined time period has elapsed since the message was transmitted to that user, then attempting transmission of the message to that user via an alternative contact mode as set forth in that user's profile.

22. The method of claim 18 further comprising the step of
g. after failing to receive a confirmation message from a user after a predetermined time period has elapsed since the message was transmitted to that user, then modifying the content of subsequent messages transmitted to other users.

23. The method of claim 18 further comprising the step of
g. confirming the identity of the user that sends a confirmation message to the notification and response system.

24. The method of claim 23 wherein the step of confirming the identity of the user that sends a confirmation message to the notification and response system is executed by checking the validity of a PIN received with the confirmation message.

25. The method of claim 23 wherein the step of confirming the identity of the user that sends a confirmation message to the notification and response system is executed by checking biometric data received with the confirmation message.
